(19) United States
(12) Patent Application Publication
(10) Pub. No.: US 2004/0132440 A1
(43) Pub. Date: Jul. 8, 2004

(54) Method of controlling the availability of a cellular radiocommunication service, terminal and cellular system for the implementation of the method

(75) Inventor: Philippe Duplessis, Colombes (FR)

Correspondence Address: PIPER RUDNICK, P. O. BOX 64807, CHICAGO, IL, 60664-0807, US

(73) Assignee: NORTEL NETWORKS LIMITED

(21) Appl. No.: 10/612,209

(22) Filed: Jul. 2, 2003

(30) Foreign Application Priority Data
Jul. 5, 2002 (FR) 02 08476

(51) Int. Cl. H04Q 7/20

(52) U.S. Cl. 455/422.1; 455/450

(57) ABSTRACT

A radio beacon is installed for broadcasting a radio signal in a protected zone. This radio signal carries system information shaped according to a broadcasting channel of a cellular radiocommunication system. This system information comprises a service restriction indication in respect of terminals situated in the protected zone. When it is detected, such an indication is stored by a terminal and transmitted to the cellular system in a call setup procedure prior to any production of audible signals.

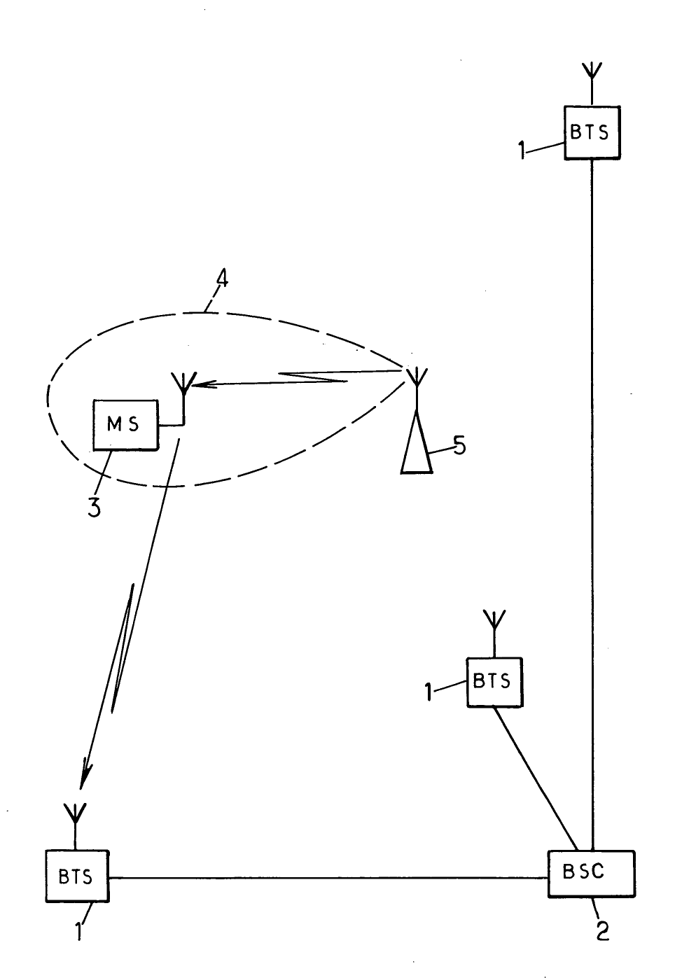

### BACKGROUND OF THE INVENTION

The present invention relates to techniques aimed at controlling the availability of a cellular radiocommunication service in certain specified zones.

With the upsurge in cellular telecommunications, the need has become apparent to restrict the use of terminals in certain zones. In general, the intended aim is to prevent the nuisance caused by untimely ringing of terminals in theatres, museums, religious buildings, etc. Nuisance to the environment may also be due to telephone conversations of indelicate users.

The prime objective of cellular systems is to achieve the most extensive availability for the service, so that they do not generally incorporate means for on the contrary restricting the use of terminals.

The most widespread technique for accomplishing this objective of restriction is the jamming of communications. By transmitting sufficient energy in the frequency band of the system in the neighborhood of the zone to be protected, any communication therein is prevented.

This crude method has several drawbacks. The need to radiate considerable energy within a relatively wide band causes interference in the network, well beyond the protected zone. Moreover, electrical consumption is considerable, and this may cause disturbances to radiation-sensitive equipment.

To attenuate these drawbacks, it is known to operate the jamming only over an appropriate part of the spectrum and/or intermittently (see e.g. European patent application No. 0 986 870). However, these more elaborate methods of jamming are relatively expensive.

Although the general idea of protection is to prevent undesirable communications, it is however useful not to prevent certain communications, such as for example emergency calls or communications from certain types of subscribers (doctors, security agents, etc.). A method of jamming is not generally capable of ensuring such selectivity in a simple manner.

French patent application No. 2 790 178 discloses another method of protection, wherein a base station of a cellular network is designed to serve exclusively a cell corresponding to the protected zone. This method has the drawback of being specific to a single network.

Usually, however, several operators have networks covering the same zones. If one desires to protect a given zone, it is not desirable to have to turn to each of the possible operators. The same reference alternatively considers that a repeater may pick up the beacon channels of the surrounding cells and retransmit them amplified in the protected zone after having modified some of the information that they carry so as to insert a restriction code. This is very complex since the information of the beacon channels must not be altered since it is useful to the communications tolerated in the zone. Furthermore, the modified beacon channel interferes with the beacon channel received directly from the cell before modification, so that the repetition must be performed at very high level if the base station is nearby. Even repetition at the maximum power allowable in a picocellular urban context might be insufficient to avoid interference.

An object of the present invention is to propose a method which is both simple and very flexible for restricting the availability of the cellular service in certain protected zones.

### SUMMARY OF THE INVENTION

The invention thus proposes a method of controlling the availibility of a cellular radiocommunication service, wherein an independent beacon is installed for broadcasting a radio signal in a protected zone. According to the invention, this radio signal carries system information shaped according to a broadcasting channel of a cellular radiocommunication system, said system information including a service restriction indication in respect of terminals situated in the protected zone. A terminal picking up said radio signal stores the service restriction indication. A procedure of call setup between a cellular system and a terminal which has stored the service restriction indication comprises a signaling sequence, prior to the production of audible signals, during which the terminal transmits the service restriction indication to said cellular system.

The beacon is a very simple device which will generally be able to operate only in transmission mode. Its transmission power may be low since its job is not to jam the communications, but simply to be detected by terminals as a channel for broadcasting system information in the cellular network.

Having regard to the low transmission power, it is easy to design the antennas of the beacons in such a way that they radiate in well-defined zones where protection is sought.

The access network of the cellular system is able to analyze the service restriction indication transmitted by the terminal so as to authorize or not continuation of the call setup procedure. This analysis may be performed in conjunction with the type of call being set up (for example ordinary or emergency call), and/or in conjunction with data for identifying the terminal. The network can also take account of data of geographical positioning of the radio beacon accompanying the service restriction indication transmitted by the terminal or of the call setup time.

The method thus offers great flexibility while calling only upon simple and cheap means, inducing only very slight interference in the network.

The invention also proposes a radiocommunication terminal, comprising means for detecting broadcasting channels emanating from radio transceivers of at least one cellular radio communication system and means for setting up calls with a cellular system through a transceiver of said system whose broadcasting channel has been detected. The detection means are arranged to further detect a radio signal broadcast by a radio beacon independent of the cellular system, said radio signal being carrying system information shaped according to a broadcasting channel of a cellular system, said system information including a service restriction indication in respect of terminals situated in a protected zone, whereby detection of said radio signal is taken into account by the call setup means. The terminal according to the invention further comprises means for storing the service restriction indication included in the system information carried by the radio signal when it is detected. The call setup means are arranged to execute a call setup procedure with the cellular system comprising a signaling sequence, prior to the production of audible signals, during which the service restriction indication stored is transmitted to the cellular system.

The invention further proposes a cellular radiocommunication system, comprising radio transceivers dispersed over a system coverage area and means of setting up calls with terminals situated within range of said radio tranceivers. The call setup means are arranged to execute a call setup procedure with at least one terminal, comprising receiving from the terminal a service restriction indication emanating from a radio beacon independent of the system, and analyzing said indication before validating call triggering.

### BRIEF DESCRIPTION OF THE DRAWINGS

The sole FIGURE is a diagrammatic view of part of a cellular system associated with a radio beacon for the implementation of the invention.

### DESCRIPTION OF PREFERRED EMBODIMENTS

A cellular radio communication system comprises base stations, or BTSs, distributed over the coverage area of the system. These base stations 1 belong to a radio access network of the system, which also comprises base station controllers 2, or BSCs.

Each BTS 1 is provided with conventional means for communicating with mobile stations 3 according to a set of multiplexed channels. Generally, one of these channels is a broadcasting channel, or beacon channel, on which the BTS broadcasts system information necessary for setting up links therewith.

By way of nonlimiting example, the case considered below is that of a cellular system of GSM (“Global System for Mobile Communications”) type which has been standardized by the ETSI (“European Telecommunications Standards Institute”). On the radio interface, this system uses frequency division multiple access (FDMA) coupled with time division multiple access (TDMA).

The beacon channel of a GSM base station is carried by a downlink frequency (or BCCH frequency). It carries three logical broadcasting channels (see 3.3.2 of GSM specification 05.02, V8.5.1, published by the ETSI in November 2000):

FCCH (“Frequency Correction Channel”) for adjusting the frequency of the receiver;

SCH (“Synchronization Channel”) for synchronizing the receiver;

BCCH (“Broadcast Control Channel”) for broadcasting local information of the system.

Each terminal 3 in idle mode has a serving BTS determined by a selection scheme based on the beacon channels. Typically, the BTS selected is that whose BCCH frequency is picked up with the greatest reception power by the terminal, in a periodic monitoring scheme. For initial selection, the terminal monitors the differences possible BCCH frequencies. Next, when it has selected a cell, it obtains from the system information of its BCCH logical channel the list of BCCH frequencies assigned to the neighboring cells, and it is the cells of this list that it monitors in a priority manner subsequently so as possibly to select a new cell.

The setting up of a call involving a terminal 3, from or to the latter, comprises a dialogue of the terminal with the BSC overseeing the terminal's serving BTS as well as with the core network (not represented) to which the BSC is linked.

In order to protect a specified zone 4 against the undesirable use of cellular terminals 3, the invention proposes to equip this zone with an independent radio beacon 5.

This beacon 5 is a radio transmission device that need not be linked to the access network. It broadcasts a radio signal which reproduces the beacon channel of a base station 1, on an available downlink frequency. The power of this radio signal is chosen to be just sufficient for it to be detected by terminals located in the zone 4. The transmission antennas of the beacon may be designed in a manner known per se so as to obtain the requisite spatial selectivity, through beam forming techniques.

The system information of the BCCH logical channel is adapted to include, in the case of a protection beacon 5, a service restriction indication for the terminal situated in the protected zone. This indication is advantageously associated with data describing the geographical location of the beacon 5 (and therefore of the zone 4). On the other hand, it will not generally be necessary to include the other types of system information provided for by the standard (sections 9.1.31 to 9.1.43 of GSM specification 04.08, V7.8.0, published by ETSI in October 2000).

The service restriction indication may designate a type of protected zone, making it possible to distinguish between various service restriction policies.

Various methods can be used for choosing the transmission frequency of the beacon 5. One possibility is to reserve a particular frequency of the spectrum for this purpose. The different cellular operators of a territory then agree with regard to this frequency, which may for example lie in the guard areas between the portions of spectrum allotted to them. Another possibility is to provide one frequency per operator, the terminals then having to poll several frequencies to make sure that they are not within range of a beacon. If need be, the frequency or frequencies liable to be used by a protection beacon 5 may be signaled in the system information broadcast by the BTSs 1 on their BCCH channels.

The ordinary scheme for monitoring the BCCH frequencies of the BTSs 1 by the terminal 3 is supplemented with a periodic monitoring of the frequency or frequencies used by the transmitters of protection beacon 5 type.

The periodicity of this additional monitoring is for example a few seconds. When the frequency of a protection beacon 5 is detected, the terminal 3 reads the local information of the BCCH, which includes the service restriction indication, even if this is not the frequency received with most power. Furthermore, the terminal 3 does not undertake any cell reselection or location update in response to detection of the beacon 5, even if its frequency is the one that the terminal receives with the most power.

In a preferred embodiment of the invention, this detection gives rise to storage by the terminal of the service restriction indication and of any associated location data.

An idle terminal may in this respect be in one of the following two states:

restricted service if the terminal has picked up the signal from a protection beacon in the course of the last monitoring period, the restriction indication and the associated data then being stored;

normal service if the terminal has not picked up any signal from a protection beacon in the course of the last monitoring period.

In accordance with the invention, if the terminal in the “restricted service” state requests a call or receives an incoming call, the signaling sequence intervening in the call setup procedure is adapted to include the transmission by the terminal of the system information received from the beacon 5 and stored.

This transmission may take place in any one of the messages prior to the production of an audible signal at the terminal level. In the GSM case, it may in particular be in an uplink message transmitted by the terminal on the SDCCH dedicated signaling channel (“Stand-alone Dedicated Control Channel”).

This information emanating from the beacon 5 and sent back up by a terminal 3 is analyzed in the cellular system, for example at the core network level, to determine whether the call setup procedure can continue. If appropriate, the network causes the setup procedure to abort.

The cellular operator can thus:

bar any call originating from the protected zone 4, except certain call numbers, in particular emergency calls;

bar any call from or to the protected zone 4, except for certain terminal numbers, detectable on the basis of the subscription classes or on the basis of relative priorities between subscribers, and possibly corresponding to subscriptions of doctors, security agents, etc.;

take account of the protected zone type indicated by the beacon, so as to apply a call restriction policy differentiated by type of zone;

take account of the location of the beacon, sent back up by the terminal 3 so as, for example, to bar calls from or to the zone 4 except for doctors registered as subscribers with domicile located less than a certain distance from the beacon;

take account of the moment of the call setup (day of the week, hour of the day) etc.

The location of the beacon also makes it possible to distinguish various protection zones of one and the same type. For example, an “auditorium” or “exhibition hall” type could form the subject of a service restriction with different schedules depending on the location of the zone, signaled by the beacon, so as to take account of the events planned in this zone.

The foregoing description dealt with GSM networks for illustrative purposes. It is however understood that the invention is applicable to any type of cellular system.

It is also applicable to situations where several cellular systems of different technologies coexist. It suffices for the multimode terminals to be capable of detecting the beacon channel of a particular technology used by the protection beacons 5.

I claim:

1. A method of controlling the availibility of a cellular radiocommunication service, comprising the steps of:
installing an independent beacon for broadcasting a radio signal in a protected zone, wherein said radio signal carries system information shaped according to a broadcasting channel of a cellular radiocommunication system, said system information including a service restriction indication in respect of terminals situated in the protected zone;
storing the service restriction indication in a terminal picking up said radio signal; and
executing a signaling sequence, prior to producing audible signals, in a call setup procedure between a cellular system and said terminal, said signaling sequence including transmitting the service restriction indication from said terminal to said cellular system.

2. The method as claimed in claim 1, wherein said service restriction indication designates a type of protected zone.

3. The method as claimed in claim 1, wherein said system information further includes data of geographical positioning of the beacon.

4. The method as claimed in claim 1, wherein the call setup procedure comprises analyzing the service restriction indication transmitted by the terminal in conjunction with a type of call being set up, so as to authorize or not continuation of the procedure.

5. The method as claimed in claim 1, wherein the call setup procedure includes analyzing the service restriction indication transmitted by the terminal in conjunction with data for identifying the terminal, so as to authorize or not continuation of the procedure.

6. A radiocommunication terminal, comprising means for detecting broadcasting channels emanating from radio transceivers of at least one cellular radiocommunication system, and means for setting up calls with a cellular system through a transceiver of said system whose broadcasting channel has been detected, wherein the detection means are arranged to further detect a radio signal broadcast by a radio beacon independent of the cellular system, said radio signal carrying system information shaped according to a broadcasting channel of a cellular system, said system information including a service restriction indication in respect of terminals situated in a protected zone, the terminal further comprising means for storing the service restriction indication included in the system information carried by the radio signal upon detection of said radio signal, and wherein the call setup means are arranged to execute a signaling sequence, prior to producing audible signals, in a call setup procedure with the cellular system, said signaling sequence including transmitting any stored service restriction indication to said cellular system.

7. A cellular radiocommunication system, comprising radio transceivers dispersed over a system coverage area, and means for setting up calls with terminals situated within range of said radio transceivers, wherein the call setup means are arranged to execute a call setup procedure with at least one terminal, comprising receiving from the terminal a service restriction indication emanating from a radio beacon independent of the system and analyzing said indication before validating call triggering.

8. The system as claimed in claim 7, wherein the analysis of the service restriction indication received from the terminal is performed in conjunction with a type of call being set up.

9. The system as claimed in claim 7, wherein the analysis of the service restriction indication received from the terminal is performed in conjunction with data for identifying the terminal.

10. The system as claimed in claim 7, wherein the service restriction indication received from the terminal designates a type of protected zone where the availibility of the cellular service is restricted.

11. The system as claimed in claim 7, wherein the service restriction indication is received from the terminal with data of geographical positioning of the radio beacon, which are taken into account in the analysis.

12. The system as claimed in claim 7, wherein the analysis of the service restriction indication received from the terminal takes into account the call setup time.
